(19) United States
(12) Patent Application Publication
(10) Pub. No.: US 2024/0360283 A1
(43) Pub. Date: Oct. 31, 2024

(54) Antistatic transparent polymer composition

(71) Applicant: ARKEMA FRANCE, COLOMBES (FR)

(72) Inventors: Quentin PINEAU, Serquigny (FR); Marie-Ange LEMAITRE, Serquigny (FR)

(73) Assignee: ARKEMA FRANCE, COLOMBES (FR)

(21) Appl. No.: 18/292,896

(22) PCT Filed: Jul. 27, 2022
(86) PCT No.: PCT/FR2022/051512

§ 371 Date: Jan. 27, 2024

(30) Foreign Application Priority Data
Jul. 28, 2021 (FR) FR2108196

(51) Int. Cl. C08G 81/00; C08G 69/10; C08G 69/32; C08L 71/02

(52) U.S. Cl. CPC C08G 81/00; C08G 69/10; C08G 69/32; C08L 71/02; C08L 2201/04; C08L 2201/10; C08L 2205/025; C08L 2205/035; C08L 2205/22

(57) ABSTRACT

The present invention relates to a copolymer having polyamide blocks and having polyether blocks comprising aromatic units, and to its use as antistatic additive. The present invention also relates to a transparent antistatic composition comprising at least one copolymer having polyamide blocks and having polyether blocks and a thermoplastic polymer matrix.

### FIELD OF THE INVENTION

The present invention relates to a copolymer having polyamide blocks and having polyether blocks comprising aromatic units, and to its use as antistatic additive. The present invention also relates to a transparent antistatic composition comprising at least one copolymer having polyamide blocks and having polyether blocks and a thermoplastic polymer matrix.

### TECHNICAL BACKGROUND

The formation and the retention of static electricity charges at the surface of most plastics are known. For example, the presence of static electricity on thermoplastic films results in these films sticking to one another, making it difficult to separate them. The presence of static electricity on packaging films can cause dust to accumulate on the objects to be packaged and thus hinder their use. Static electricity can also damage microprocessors or constituents of electronic circuits. Static electricity can in addition bring about the combustion or the explosion of flammable materials, such as, for example, expandable polystyrene beads which contain pentane.

Antistatic agents for polymers are described in the prior art. They are generally ionic surfactants of the sulfonates or ethoxylated amines type which are added to the polymers. However, the antistatic properties of the polymers incorporating these surfactants depend on the ambient humidity and they are thus not permanent. This is because these surfactants tend to migrate to the surface of the polymers and then to disappear.

Hydrophilic copolymers having polyamide blocks and polyether blocks constitute another category of antistatic agents, which exhibit the advantage of not migrating. Their antistatic properties are permanent and independent of ambient humidity. Mention may in particular be made of the patents JP 60023435 A, EP 242 158, WO 0110951, EP 1 046 675 and EP 829 520, which describe polymer substrates rendered antistatic by addition to their composition of a copolymer having polyether blocks and polyamide blocks.

Moreover, it is now sought to confer antistatic properties on transparent polymers. However, it turns out that, when antistatic additives are added to the transparent polymer matrix, the transparency of the combination is damaged. This is because, as described in detail below, antistatic additives tend to become positioned on the surface of the material. While this arrangement is an advantage for the antistatic properties conferred on the material, it has the disadvantage of influencing the transparency of the material.

Specifically, it has been observed that, when sulfonic acid salts, known as antistatic additives, are added to a transparent polymeric matrix, the antistatic properties are no longer permanent. The salts tend to migrate to the surface and are removed little by little following repeated rubbing actions or else following cleaning operations on this surface.

Block polymers have also been used as an antistatic additive for transparent matrices.

The document US 2006/0281860 relates to a thermoplastic resin for producing moldings having a satisfactory transparency, good permanent antistatic properties and good mechanical properties. The transparent resin composition of this document comprises at least a block polymer and a transparent resin, with a refractive index difference between the block polymer and the transparent resin which is not greater than 0.01. The block copolymer is composed of a lipophilic block containing an aromatic ring having a refractive index of not less than 1.575 and a volume resistivity of 10¹² to 10¹⁷ Ω·cm and a hydrophilic block containing an aromatic ring having a volume resistivity of 10⁵ to 10¹¹ Ω·cm and a thermal degradation temperature of 250 to 380° C.

The document JP 2016166332 relates to an antistatic agent, which gives a molded article an excellent transparency and also antistatic properties and mechanical properties which are permanent. The antistatic agent contains a block polymer and has a refractive index of 1500-1600, the block polymer having a block of at least one hydrophobic polymer chosen from the group consisting of polyamides, polyolefins and polyamide-imides, a block of a hydrophilic polymer and a block of a hydrophobic polyether containing an aromatic ring as constituent units.

However, these proposed solutions are not satisfactory.

There thus exists a real need to provide a transparent composition having permanent antistatic properties, without affecting the mechanical properties of the composition.

### SUMMARY OF THE INVENTION

The invention relates firstly to a block copolymer comprising at least one polyamide block and at least one polyether block (PEBA), characterized in that:
the polyamide block comprises at least one unit of formula XDY, in which:

XD denotes a unit resulting from m-xylylenediamine (MXD), p-xylylenediamine (PXD) and their mixtures, and preferably m-xylylenediamine, and

Y denotes a unit resulting from a linear or branched aliphatic, cycloaliphatic or aromatic dicarboxylic acid comprising from 4 to 36 carbon atoms;
the polyether block comprises ethylene oxide units, in a content of greater than or equal to 20%, with respect to the total weight of the copolymer;
the content of aromatic units is from 20% to 80%, with respect to the total weight of the copolymer.

Preferably, the copolymer exhibits a refractive index of greater than or equal to 1.51.

According to certain embodiments, the dicarboxylic acid (Y) is chosen from aliphatic diacids having from 6 to 36 carbon atoms, preferably from 6 to 18 carbon atoms, more preferentially from 9 to 18 carbon atoms, in particular 1,10-decanedicarboxylic acid (denoted 10), 1,11-undecanedicarboxylic acid (denoted 11), 1,12-dodecanedicarboxylic acid (denoted 12), 1,14-tetradecanedicarboxylic acid (denoted 14) and 1,18-octadecanedicarboxylic acid (denoted 18), and aromatic dicarboxylic acids having from 6 to 36 carbon atoms, in particular terephthalic acid (denoted T), isophthalic acid (denoted I), naphthalenedicarboxylic acid (denoted N) and 2,5-furandicarboxylic acid.

According to certain embodiments, the polyamide block comprises at least one additional unit of formula Z, in which Z denotes a unit obtained by polycondensation of amino acid units, of lactam units or else of units corresponding to the formula (Ca diamine). (Cb dicarboxylic acid), in which Ca and Cb can each comprise from 4 to 36 carbon atoms.

According to certain embodiments, the polyamide block is chosen from: XDI, XDT, XD10/XDI, XD10/XDT, 11/XDI, 11/XDT, XD10/XDI/XDT or 11/XDI/XDT.

According to certain embodiments, the ethylene oxide units result from polyethylene glycol or from polyetheramines comprising ethylene oxide units.

The invention also relates to a transparent antistatic polymer composition comprising: (a) at least one block copolymer, comprising at least one polyamide block and at least one polyether block, in which the polyamide block comprises at least one unit of formula AY, in which:
A denotes a unit resulting from a linear or branched aliphatic, cycloaliphatic or alkylaromatic diamine comprising from 4 to 36 carbon atoms, and
Y denotes a unit resulting from a dicarboxylic acid as defined above;
the content of polyether block of the ethylene oxide units is greater than or equal to 30%, with respect to the total weight of the copolymer;
the content of aromatic units is from 20% to 80%, with respect to the total weight of the copolymer; and
(b) a transparent thermoplastic polymer matrix comprising at least one thermoplastic polymer exhibiting a refractive index of greater than or equal to 1.51.

Preferably, the block copolymer present in the composition exhibits a refractive index of greater than or equal to 1.51.

According to certain embodiments, the diamine (A) is chosen from butanediamine (denoted 4), pentanediamine (denoted 5), hexanediamine (denoted 6), heptanediamine (denoted 7), octanediamine (denoted 8), nonanediamine (denoted 9), decanediamine (denoted 10), undecanediamine (denoted 11), dodecanediamine (denoted 12), tridecanediamine (denoted 13), tetradecanediamine (denoted 14), hexadecanediamine (denoted 16), octadecanediamine (denoted 18), octadecenediamine (denoted 18), eicosanediamine (denoted 20), docosanediamine (denoted 22) and the diamines obtained from fatty acids, bis(3-methyl-4-aminocyclohexyl) methane (denoted BMACM or MACM), bis(p-aminocyclohexyl) methane (denoted PACM) and isopropylidenedi (cyclohexylamine) (denoted PACP), m-xylylenediamine (MXD), p-xylylenediamine (PXD) and their mixtures, and preferably m-xylylenediamine.

According to certain embodiments, the ethylene oxide units result from polyethylene glycol or from polyetheramines comprising ethylene oxide units.

According to certain embodiments, the thermoplastic polymer of the matrix is chosen from polycarbonate (PC), polystyrene, polyethylene terephthalate (PET), polyethylene terephthalate glycol (PETG), polysulfone, acrylonitrile-butadiene-styrene (ABS), styrene-acrylonitrile (SAN), acrylonitrile-styrene-acrylate (ASA), their copolymers and their alloys.

According to one embodiment, the polyamide block additionally comprises at least one unit obtained by polycondensation of amino acid or lactam units.

According to certain embodiments, the polyamide block of the copolymer is chosen from 6I/6T, 410/4T, 11/10T, 11T, 5I/5T, XDI, 11/XDI, XDT, XD10/XDI, XD10/XDT, 11/XDT, XD10/XDI/XDT or 11/XDI/XDT, and/or the thermoplastic polymer matrix is chosen from PC, PET or PETG, and/or the content of aromatic units is from 35% to 60%, with respect to the total weight of the copolymer.

According to certain embodiments, the composition additionally comprises an organic salt.

The invention also relates to the use of the copolymer as described above as antistatic additive.

The present invention makes it possible to meet the need expressed above. It provides a transparent composition, more particularly a transparent polymer composition, having permanent antistatic properties, without affecting the mechanical properties of the composition.

This is accomplished by virtue of the incorporation of a specific copolymer into a transparent thermoplastic polymer matrix. More particularly, on the one hand, the presence of a copolymer having polyamide blocks and having polyether blocks comprising a content by weight of ethylene oxide units (as polyether blocks) of greater than or equal to 20%, with respect to the weight of the copolymer, and, on the other hand, the presence of the aromatic groups in the copolymer at a content by weight of 20% to 80%, with respect to the weight of the copolymer, make it possible not only to improve the antistatic properties of the composition but also to obtain a high refractive index. This refractive index, which can be greater than or equal to 1.51, is close to the refractive index of the matrix used, which makes it possible to form a composition without impacting the transparency of the matrix.

### DETAILED DESCRIPTION

The invention is now described in more detail and in a nonlimiting way in the description which follows.

The nomenclature used to define the polyamides is described in the standard ISO 1874-1:1992, “Plastics-Polyamide (PA) moulding and extrusion materials-Part 1: Designation”, in particular on page 3 (Tables 1 and 2), and is well known to a person skilled in the art.

The term “copolymer” is understood to mean a polymer resulting from the copolymerization of at least two types of monomer which are chemically different, referred to as comonomers. A copolymer is thus formed of at least two different repeat units. It can also be formed of three or more repeat units. More specifically, the term “block copolymer” is understood to denote copolymers in the abovementioned meaning, in which at least two distinct monomer blocks are linked by a covalent bond. The length of the blocks can be variable. Preferably, the blocks are composed of 1 to 1000, preferably 1 to 100 and in particular 1 to 50 repeat units, respectively. The link between the two monomer blocks can sometimes require an intermediate nonrepeat unit known as a junction block.

Block copolymer comprising at least one polyamide block and at least one polyether block (PEBA)

PEBA copolymers result from the polycondensation of polyamide blocks having reactive ends with polyether blocks having reactive ends, such as, inter alia:
1) polyamide blocks having diamine chain ends with polyoxyalkylene blocks having di(carboxylic acid) chain ends,
2) polyamide blocks having di(carboxylic acid) chain ends with polyoxyalkylene blocks having diamine chain ends, obtained, for example, by cyanoethylation and hydrogenation of α,ω-dihydroxylated aliphatic polyoxyalkylene blocks, known as polyetherdiols, or also
3) polyamide blocks having di(carboxylic acid) chain ends with polyetherdiols, the products obtained being, in this particular case, polyetheresteramides.

The polyamide blocks having di(carboxylic acid) chain ends originate, for example, from the condensation of polyamide precursors in the presence of a dicarboxylic acid chain limiter.

The polyamide blocks having diamine chain ends originate, for example, from the condensation of polyamide precursors in the presence of a diamine chain limiter.

The polymers having polyamide blocks and polyether blocks can also comprise randomly distributed units.

### Polyamide Block

In the unit of formula XDY according to the invention:

XD denotes a unit resulting from m-xylylenediamine, p-xylylenediamine and their mixtures, and preferably m-xylylenediamine, and

Y denotes a unit resulting from a dicarboxylic acid comprising from 4 to 36 carbon atoms, preferably from 6 to 14 carbon atoms, more particularly isophthalic acid or terephthalic acid.

The dicarboxylic acid (Y) can be linear or branched aliphatic, cycloaliphatic or aromatic.

The aliphatic diacid can be chosen from succinic acid (n=4), pentanedioic acid (n=5), adipic acid (n=6), heptanedioic acid (n=7), octanedioic acid (n=8), azelaic acid (n=9), sebacic acid (n=10), undecanedioic acid (n=11), dodecanedioic acid (n=12), brassylic acid (n=13), tetradecanedioic acid (n=14), hexadecanedioic acid (n=16), octadecanedioic acid (n=18), octadecenedioic acid (n=18), eicosanedioic acid (n=20), docosanedioic acid (n=22) and fatty acid dimers. The abovementioned fatty acid dimers are dimerized fatty acids obtained by oligomerization or polymerization of unsaturated monobasic fatty acids having a long hydrocarbon chain (such as linoleic acid and oleic acid), as described in particular in the document EP 0 471 566.

The cycloaliphatic diacid can comprise the following carbon backbones: norbornylmethane, cyclohexylmethane, dicyclohexylmethane, dicyclohexylpropane, di(methylcyclohexyl) or di(methylcyclohexyl) propane.

The aromatic diacid can be chosen from terephthalic acid (denoted T), isophthalic acid (denoted I) and naphthalenic diacids (denoted N), 2,5-furanedicarboxylic acid, and naphthalenic diacids.

Advantageously, the XDY units are chosen from MXD10, MXD11, PXD10, PXD11, MXDT, MXDI, PXDT and PXDI.

The additional unit Z according to the invention designates a unit obtained by polycondensation of amino acid units, of lactam units or else of units corresponding to the formula (Ca diamine). (Cb diacid). The polyamide block can then be of formula XDY/Z.

The amino acid units can be chosen from 9-aminononanoic acid, 10-aminodecanoic acid, 10-aminoundecanoic acid, 12-aminododecanoic acid and 11-aminoundecanoic acid and also its derivatives, in particular N-heptyl-11-aminoundecanoic acid.

The lactam units can be chosen from pyrrolidinone, 2-piperidinone, enantholactam, caprylolactam, pelargolactam, decanolactam, undecanolactam and lauryllactam.

As regards the units corresponding to the formula (Ca diamine). (Cb diacid), the (Ca diamine) unit is chosen from linear or branched aliphatic diamines or cycloaliphatic diamines, and the (Cb diacid) unit, which can be chosen from linear or branched aliphatic, cycloaliphatic or aromatic diacids, is as defined above for the unit Y.

The linear and aliphatic diamine, typically of formula H₂N—(CH₂)ₘ-NH₂, can be chosen from butanediamine (m=4), pentanediamine (m=5), hexanediamine (m=6), heptanediamine (m=7), octanediamine (m=8), nonanediamine (m=9), decanediamine (m=10), undecanediamine (m=11), dodecanediamine (m=12), tridecanediamine (m=13), tetradecanediamine (m=14), hexadecanediamine (m=16), octadecanediamine (m=18), octadecenediamine (m=18), eicosanediamine (m=20), docosanediamine (m=22) and diamines obtained from fatty acids.

When the diamine is aliphatic and branched, it can comprise one or more methyl or ethyl substituent(s) on the main chain, for example be chosen from 2,2,4-trimethyl-1,6-hexanediamine, 2,4,4-trimethyl-1,6-hexanediamine, 1,3-diaminopentane, 2-methyl-1,5-pentanediamine or 2-methyl-1,8-octanediamine.

The cycloaliphatic diamine can be chosen from bis(3,5-dialkyl-4-aminocyclohexyl) methane, bis(3,5-dialkyl-4-aminocyclohexyl) ethane, bis(3,5-dialkyl-4-aminocyclohexyl) propane, bis(3,5-dialkyl-4-aminocyclohexyl) butane, bis(3-methyl-4-aminocyclohexyl) methane (BMACM or MACM), bis(p-aminocyclohexyl) methane (PACM) and isopropylidenedi (cyclohexylamine) (PACP). It can also comprise the following carbon backbones: norbornylmethane, cyclohexylmethane, dicyclohexylpropane, di(methylcyclohexyl) or di(methylcyclohexyl) propane. A nonexhaustive list of these cycloaliphatic diamines is given in the publication “Cycloaliphatic Amines” (Encyclopedia of Chemical Technology, Kirk-Othmer, 4th Edition (1992), pages 386-405).

Advantageously, the PA blocks of the formulae XDY/Z are chosen from XD10/XD11, 11/XDI, XD10/XDI/XDT, 11/XDI/XDT, XD10/XDI/XDN or 11/XDI/XDN blocks.

The PEBA copolymer can comprise polyamide blocks in a content of greater than or equal to 35% by weight, with respect to the total weight of the copolymer.

Preferably, the number-average molar mass Mn of the PA blocks is of between 400 and 20 000 g/mol and preferably between 500 and 10 000 g/mol.

### Polyether Block

The polyether blocks consist of alkylene oxide units. These units can usually be ethylene oxide units, propylene oxide units or tetrahydrofuran units (which result in polytetramethylene glycol sequences).

The copolymer according to the invention comprises ethylene oxide units (PEG).

The copolymer can optionally comprise propylene oxide units (PPG), polytrimethylene oxide units (PO3G) and/or tetramethylene oxide units (PTMG), also called polytetrahydrofuran. The PEBA copolymers can comprise, in their chain, several types of polyethers, it being possible for the copolyethers to be in block or random form.

The polyether blocks can be polyetherdiol blocks, which are either used as is and copolycondensed with polyamide blocks having carboxyl end groups, or they are aminated in order to be converted into polyetherdiamines and condensed with polyamide blocks having carboxyl end groups.

The PEBA copolymer according to the invention comprises ethylene oxide units at a content of greater than or equal to 20%, preferably of greater than or equal to 25%, preferably of greater than or equal to 30%, preferably of greater than or equal to 40% and more preferably of greater than or equal to 50% by weight, with respect to the total weight of the copolymer. Preferably, the PEBA copolymer according to the invention comprises ethylene oxide units at a content of 20% to 80% and more preferably of 25% to 55% by weight, with respect to the total weight of the copolymer.

According to certain embodiments, the copolymer of the composition additionally comprises at least one polyether other than PEG, chosen from PTMG, PPG, PO3G and their blends.

Use may also be made of blocks obtained by oxyethylation of bisphenols, such as, for example, bisphenol A. The latter products are described in the patent EP 613 919.

Preferably, the copolymer according to the invention does not comprise a polyether block resulting from ethoxylated bisphenol. This is because it has been found that, in the absence of this polyether unit, the mechanical properties conferred by the copolymer were reinforced.

The polyether blocks can also consist of ethoxylated primary amines. Mention may be made, by way of example of ethoxylated primary amines, of the products of formula:

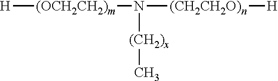

in which m and n are of between 1 and 20, and x is between 8 and 18. These products are commercially available under the Noramox® brand from Arkema and under the Genamin® brand from Clariant.

The polyether blocks can comprise polyoxyalkylene blocks having NH₂ chain ends, it being possible for such blocks to be obtained by cyanoacetylation of α,ω-dihydroxylated aliphatic polyoxyalkylene blocks, known as polyetherdiols. More particularly, use can be made of the Jeffamine products (for example Jeffamine® D400, D2000, ED 2003, XTJ 542, which are commercial products from Huntsman, also described in the patent documents JP2004346274, JP2004352794 and EP 1 482 011).

Preferably, the ethylene oxide units can result from polyethylene glycol or from polyetheramines comprising ethylene oxide units.

The general method for the two-stage preparation of PEBA copolymers having ester bonds between the PA blocks and the PE blocks is known and is described, for example, in the French patent FR 2 846 332. The general method for the preparation of the PEBA copolymers of the invention having amide bonds between the PA blocks and the PE blocks is known and is described, for example, in the European patent EP 1 482 011. The polyether blocks can also be mixed with polyamide precursors and a diacid chain limiter in order to prepare polymers having polyamide blocks and polyether blocks which have randomly distributed units (one-stage process).

Of course, the name PEBA in the present description of the invention relates just as well to the Pebax® products sold by Arkema, to the Vestamid® products sold by Evonik® and to the Grilamid® products sold by EMS, as to the PEBA products of Pelestat® type sold by Sanyo or to any other PEBA product from other suppliers.

Advantageously, the PEBA copolymers have PA blocks made of MXD10, MXD11, PXD10, PXD11, MXDT, MXDI, PXDT and PXDI; and polyetherdiol or polyetheramine blocks comprising ethylene oxide units.

More preferably, the copolymer according to the invention is chosen from: PA MXD10-PEG, PA MXD11-PEG, PA PXD10-PEG, PA PXD11-PEG, PA MXDT-PEG, PA MXDI-PEG, PA PXDT-PEG, PA PXDI-PEG and/or their mixtures.

### Aromatic Units

The PEBA copolymer according to the invention comprises from 20% to 80%, preferably from 20% to 60%, preferentially from 25% to 55%, by weight, with respect to the total weight of the copolymer, of aromatic units.

The term “aromatic units” is understood to mean, within the context of the invention, each unit comprising an aromatic group resulting from a monomer. This unit can be present in the PA block and/or the PE block of the PEBA copolymer, for example the XD units, and optionally, if they are present, the terephthalic or isophthalic units, or also the ethoxylated bisphenol. Thus, any unit which comprises an aromatic group is taken into account for the calculation of this content by weight.

According to one embodiment, the block copolymer according to the invention consists of at least one polyamide block and at least one polyether block, characterized in that:
the polyamide block comprises at least one unit of formula XDY, in which:

XD denotes a unit resulting from m-xylylenediamine, p-xylylenediamine and their mixtures, and preferably m-xylylenediamine; and

Y denotes a unit resulting from a linear or branched aliphatic, cycloaliphatic or aromatic dicarboxylic acid comprising from 4 to 36 carbon atoms;
the polyether block comprises ethylene oxide units, in a content of greater than or equal to 20%, with respect to the total weight of the copolymer;
the content of aromatic units is from 20% to 80%, with respect to the total weight of the copolymer; and
the copolymer exhibits a refractive index of greater than or equal to 1.51.

According to certain embodiments, the copolymer according to the invention is a block copolymer comprising three different types of blocks (referred to as “triblock” in the present description of the invention), which result from the condensation of several of the blocks. Said triblock can be copolyetheresteramides or copolyetheramideurethanes, in which:
the percentage by weight of polyamide blocks is greater than 10%;
the percentage by weight of PEG blocks is greater than 50%;
with regard to the total triblock weight.

The copolymer according to the invention exhibits a refractive index of greater than or equal to 1.51, preferably of greater than or equal to 1.52, preferably of greater than or equal to 1.53 and more preferably of greater than or equal to 1.55. For example, the refractive index can be from 1.51 to 1.52; or from 1.52 to 1.54; or from 1.54 to 1.56; or from 1.56 to 1.58; or from 1.58 to 1.60; or from 1.60 to 1.62; or from 1.62 to 1.64; or 1.64 to 1.66; or from 1.66 to 1.68; or from 1.68 to 1.70. The refractive index can be measured in a known way using an Abbe refractometer according to the standard ISO 489-1999.

The number-average molar mass of the polyamide blocks in the PEBA copolymer can have a value, for example, preferably from 400 to 10 000 g/mol, more preferentially from 500 to 10 000 g/mol. In embodiments, the number-average molar mass of the polyamide blocks in the PEBA copolymer has a value from 400 to 500 g/mol, or from 500 to 600 g/mol, or from 600 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol.

The number-average molar mass of the polyether blocks can have a value preferably from 100 to 3000 g/mol, more preferentially from 200 to 3000 g/mol. In embodiments, the number-average molar mass of the polyether blocks has a value from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol.

The number-average molar mass can be set by the content of chain limiter. It can be calculated according to the equation:

$${M}_{n} = {n}_{monomer} \times {MW}_{repeat unit} / {n}_{chain limiter} + {MW}_{chain limiter}$$

In this formula, nₘₒₙₒₘₑᵣ represents the number of moles of monomer, n_{chain} limiter represents the number of moles of diacid limiter in excess, MW_{repeat unit} represents the molar mass of the repeat unit and MW_{chain limiter} represents the molar mass of the diacid in excess.

Protocols for measuring Mn are described in detail in the paper “Synthesis and characterization of poly (copolyethers-block-polyamides)-II. Characterization and properties of the multiblock copolymers”, Maréchal et al., Polymer, Volume 41, 2000, 3561-3580.

Advantageously, the ratio by weight of the polyamide blocks with respect to the polyether blocks of the copolymer has a value from 0.1 to 20, preferably from 0.5 to 18, more preferentially still from 0.6 to 15. This ratio by weight can be calculated by dividing the number-average molar mass of the polyamide blocks by the number-average molar mass of the polyether blocks. In particular, the ratio by weight of the polyamide blocks with respect to the polyether blocks of the copolymer can be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Advantageously, the PEBA copolymer has a Shore D hardness of greater than or equal to 30. The hardness measurements can be carried out according to the standard ISO 7619-1.

Advantageously, the copolymer exhibits an inherent viscosity of between 0.6 and 2, preferably of between 0.6 and 1.5, preferably between 0.8 and 1.4.

In the present description, the inherent viscosity is measured at a polymer concentration of 0.5% by weight in solution in meta-cresol with regard to the total weight of the solution, at 20° C., by means of a Ubbelohde viscometer.

The PEBA copolymer described above can be used as antistatic additive in a composition (for example, in a composition comprising a thermoplastic polymer matrix) in order to improve the antistatic properties of said composition.

### Antistatic Transparent Polymer Composition

The term “transparent composition” is understood to mean a composition exhibiting a transmittance at least equal to 88% according to the standard ASTM D1003-97/ISO 13468 and a haze of less than 15%, preferably of less than 10%, preferably of less than 5%, according to the standard ASTM D1003-97, these two properties being measured at 560 nm on a plate with a thickness of 2 mm.

The term “antistatic composition” is understood to mean a composition, the surface resistivity (or superficial resistivity) of which is less than 1012 ohm/square, measured according to the standard ASTM D257.

The polyamide block of the copolymer (a) comprises at least one unit of formula AY, in which: A denotes a unit resulting from a linear or branched aliphatic, cycloaliphatic or alkylaromatic diamine, and

Y denotes a unit resulting from a dicarboxylic acid as defined above.

The linear or branched aliphatic and cycloaliphatic diamines are as defined above for the Ca diamine.

The alkylaromatic diamine can be chosen from m-xylylenediamine and p-xylylenediamine.

According to one embodiment, the unit A is chosen from butanediamine (denoted 4), pentanediamine (denoted 5), hexanediamine (denoted 6), heptanediamine (denoted 7), octanediamine (denoted 8), nonanediamine (denoted 9), decanediamine (denoted 10), undecanediamine (denoted 11), dodecanediamine (denoted 12), tridecanediamine (denoted 13), tetradecanediamine (denoted 14), hexadecanediamine (denoted 16), octadecanediamine (denoted 18), octadecenediamine (denoted 18), eicosanediamine (denoted 20), docosanediamine (denoted 22) and the diamines obtained from fatty acids, bis(3-methyl-4-aminocyclohexyl) methane (denoted BMACM or MACM), bis(p-aminocyclohexyl) methane (denoted PACM) and isopropylidenedi (cyclohexylamine) (denoted PACP), m-xylylenediamine, p-xylylenediamine and their mixtures, and preferably m-xylylenediamine.

The diacid Y is as defined above.

The polyether block is as defined above.

According to one embodiment, the polyamide block included in the composition additionally comprises at least one unit obtained by polycondensation of amino acid or lactam units as described above.

Preferably, the polyamide blocks of the copolymer present in the composition according to the invention are chosen from 6I/6T, 410/4T, 11/10T, 11T, 5I/5T, XDI, 11/XDI, XDT, XD10/DXI, XD10/DXT, 11/XDT, XD10/XDI/XDT, 11/XDI/XDT, XD10/XDI/XDN or 11/XDI/XDN.

According to certain embodiments, the copolymer included in the composition according to the invention can be a triblock, the third block being as described above.

The number-average molar mass of the polyamide blocks in the PEBA copolymer preferably has a value from 400 to 10 000 g/mol, more preferentially from 500 to 6000 g/mol. In embodiments, the number-average molar mass of the polyamide blocks in the PEBA copolymer has a value from 400 to 500 g/mol, or from 500 to 600 g/mol, or from 600 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol.

The number-average molar mass of the polyether blocks has a value preferably from 100 to 3000 g/mol, more preferentially from 200 to 2000 g/mol. In embodiments, the number-average molar mass of the polyether blocks has a value from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol.

Advantageously, the ratio by weight of the polyamide blocks with respect to the polyether blocks of the copolymer has a value from 0.1 to 20, preferably from 0.5 to 18, more preferentially still from 0.6 to 15. This ratio by weight can be calculated by dividing the number-average molar mass of the polyamide blocks by the number-average molar mass of the polyether blocks. In particular, the ratio by weight of the polyamide blocks with respect to the polyether blocks of the copolymer can be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Advantageously, the copolymer having polyamide blocks and polyether blocks has a Shore D hardness of greater than or equal to 30. The hardness measurements can be carried out according to the standard ISO 7619-1.

The copolymer included in the composition according to the invention exhibits a refractive index of greater than or equal to 1.51, preferably of greater than or equal to 1.52, preferably of greater than or equal to 1.53 and more preferably of greater than or equal to 1.55. For example, the refractive index can be from 1.51 to 1.52; or from 1.52 to 1.54; or from 1.54 to 1.56; or from 1.56 to 1.58; or from 1.58 to 1.60; or from 1.60 to 1.62; or from 1.62 to 1.64; or 1.64 to 1.66; or from 1.66 to 1.68; or from 1.68 to 1.70. The refractive index can be measured in a known way using an Abbe refractometer according to the standard ISO 489-1999.

Advantageously, the copolymer exhibits an inherent viscosity of between 0.6 and 2, preferably of between 0.6 and 1.5, preferably of between 0.8 and 1.4.

The composition according to the invention can have a content by weight of PEBA copolymer of 0.1% to 45% and preferably of 3% to 35%, preferentially of 5% to 30%, or more preferentially still of 5% to 20%, with respect to the weight of the composition.

The composition according to the invention also comprises a transparent thermoplastic polymer matrix exhibiting a refractive index of greater than or equal to 1.51.

Preferably, the refractive index difference between the copolymer and the transparent thermoplastic polymer matrix is less than 0.02.

This thermoplastic matrix comprises at least one thermoplastic polymer, which is a homopolymer or copolymer, chosen from: polyolefins, polyamides, fluoropolymers, saturated polyesters, polycarbonate (PC), styrene resins, polysulfones, copolymers having polyamide blocks and polyether blocks, copolymers having polyester blocks and polyether blocks, copolymers having polyamide blocks, having polyether blocks and having polyester blocks, copolymers of ethylene and of an alkyl (meth)acrylate, copolymers of ethylene and of vinyl alcohol (EVOH), acrylonitrile-butadiene-styrene (ABS), polysulfone, styrene-acrylonitrile (SAN), acrylonitrile-styrene-acrylate (ASA), polyacetal, polyketones, their copolymers and their alloys.

According to preferred embodiments, the thermoplastic matrix can comprise a polymer chosen from polycarbonate, polystyrene, polyethylene terephthalate, polyethylene terephthalate glycol, polysulfone, acrylonitrile-butadiene-styrene (ABS), styrene-acrylonitrile (SAN), acrylonitrile-styrene-acrylate (ASA), their copolymers and their alloys.

More particularly, the matrix of the composition according to the invention is chosen from polycarbonate, polyterephthalate and polyethylene terephthalate glycol.

The term “matrix” is understood to mean, within the meaning of the present invention, a material present in a content of greater than 50% by weight of the composition.

According to one embodiment of the composition according to the invention, the polyamide block of the copolymer is chosen from 6I/6T, 410/4T, 11/10T, 11T, 5I/5T, XDI, 11/XDI, XDT, XD10/XDI, XD10/XDT, 11/XDT, XD10/XDI/XDT or 11/XDI/XDT, the thermoplastic polymer matrix is chosen from PC, PET or PETG and the content of aromatic units is from 35% to 60%, with respect to the total weight of the copolymer.

The composition according to the invention can have a content by weight of thermoplastic matrix of 55% to 99.9% and preferably of 65% to 97%, preferentially of 70% to 95%, more preferentially still of 80% to 93%, with respect to the weight of the composition.

Advantageously, the composition of the invention, by virtue of its permanent antistatic properties, with a surface (or superficial) resistivity of less than 1012 ohm/square, does not require, and thus does not comprise, an organic salt.

Nevertheless, it is possible to incorporate an organic salt in the composition according to the invention, in order to further improve its antistatic performance qualities.

Advantageously, the composition according to the invention additionally comprises from 0.1% to 10%, preferably from 0.1% to 5%, by weight of at least one organic salt in the molten state, with respect to the total weight of the composition.

Organic salts are salts consisting of organic cations combined with inorganic or organic anions.

Said at least one organic salt is added in the molten state, that is to say when the organic salt is at a temperature greater than its melting point. Preferably, said at least one organic salt has a melting point of less than 300° C., preferably of less than 200° C., preferably of less than 100° C., and then advantageously constitutes an ionic liquid, preferably of less than 30° C. Ionic liquids in particular have the main properties of being nonvolatile (no diffusion into the atmosphere of volatile organic compounds), nonflammable (thus easy to handle and to store), stable at high temperature (up to 400° C. for some), very good conductors and very stable with regard to water and oxygen.

Advantageously, said at least one organic salt comprises at least one cation comprising at least one of the following molecules: ammonium, sulfonium, pyridinium, pyrrolidinium, imidazolium, imidazolinium, phosphonium, lithium, guanidinium, piperidinium, thiazolium, triazolium, oxazolium, pyrazolium and their mixtures.

Advantageously, said at least one organic salt comprises at least one anion comprising at least one of the following molecules: imides, in particular bis(trifluoromethanesulfonyl) imide (abbreviated NTf₂⁻); borates, in particular tetrafluoroborate (abbreviated BF₄⁻); phosphates, in particular hexafluorophosphate (abbreviated PF₆⁻); phosphinates and phosphonates, in particular alkylphosphonates; amides, in particular dicyanamide (abbreviated DCA⁻); aluminates, in particular tetrachloroaluminate (AlCl₄⁻), halides (such as bromide, chloride, iodide, and the like, anions), cyanates, acetates (CH₃COO⁻), in particular trifluoroacetate; sulfonates, in particular methanesulfonate (CH₃SO₃⁻) or trifluoromethanesulfonate; sulfates, in particular ethyl sulfate or hydrogen sulfate, and their mixtures.

The term “organic salt”, within the meaning of the invention, is understood more particularly to mean any organic salt which is stable at the temperatures used during the synthesis of the block copolymer according to the process of the invention. A person skilled in the art can refer to the technical data sheets of the organic salts, which indicate the limiting decomposition temperature of each organic salt.

Mention may in particular be made, by way of examples of organic salts which can be used in the composition according to the invention, of organic salts based on ammonium cation, based on imidazolium cation or on imidazolinium cation, based on pyridinium cation, based on dihydropyridinium cation, based on tetrahydropyridinium cation, based on pyrrolidinium cation, based on guanidine cation or based on phosphonium cation.

Organic salts based on ammonium cation combine, for example:
an N,N,N-trimethyl-N-propylammonium cation with a bis(trifluoromethanesulfonyl) imide anion;
an N,N, N-trimethyl-N-butylammonium or N,N,N-trimethyl-N-hexylammonium cation with an anion chosen from bromide, tetrafluoroborate, hexafluorophosphate or bis(trifluoromethanesulfonyl) imide;
an N,N,N-tributyl-N-methylammonium cation with an iodide, bis(trifluoromethanesulfonyl) imide or dicyanamide anion;
a tetraethylammonium cation with a tetrafluoroborate anion;
a (2-hydroxyethyl)trimethylammonium cation with a dimethyl phosphate anion;
a di(2-hydroxyethyl) ammonium cation with a trifluoroacetate anion;
an N,N-di(2-methoxy)ethylammonium cation with a sulfamate anion;
an N,N-dimethyl (2-hydroxyethyl) ammonium cation with a 2-hydroxyacetate or trifluoroacetate anion;
an N-ethyl-N,N-dimethyl (2-methoxyethyl) ammonium cation with a bis(trifluoromethylsulfonyl) imide anion;
an ethyldimethylpropylammonium cation and a bis(trifluoromethylsulfonyl) imide anion;
a methyltrioctylammonium cation and a bis(trifluoromethylsulfonyl) imide anion;
a methyltrioctylammonium cation and a trifluoroacetate or trifluoromethylsulfonate anion;
a tetrabutylammonium cation and a bis(trifluoromethylsulfonyl) imide anion;
a tetramethylammonium cation and a bis [oxalato (2-)] borate or tris(pentafluoroethyl) trifluorophosphate anion.

Mention may also be made of imidazole-based organic salts, such as disubstituted imidazoles, monosubstituted imidazoles or trisubstituted imidazoles; in particular of those based on imidazolium cation or imidazolinium cation.

Mention may be made of organic salts based on imidazolium cation combining, for example:
an N-methylimidazolium cation with a chloride anion;
a 1-ethyl-3-methylimidazolium cation with a chloride, bromide, tetrafluoroborate, hexafluorophosphate, trifluoromethanesulfonate, bis(trifluoromethanesulfonyl) imide, tetrachloroaluminate, ethylphosphonate or methylphosphonate, methanesulfonate, ethyl sulfate or ethylsulfonate anion;
a 1-butyl-3-methylimidazolium cation with a chloride, bromide, tetrafluoroborate, hexafluorophosphate, trifluoromethanesulfonate, bis(trifluoromethanesulfonyl) imide, tetrachloroaluminate, acetate, hydrogen sulfate, trifluoroacetate or methanesulfonate anion;
a 1,3-dimethylimidazolium cation with a methylphosphonate anion;
a 1-propyl-2,3-dimethylimidazolium cation with a bis(trifluoromethanesulfonyl) imide anion;
a 1-butyl-2,3-dimethylimidazolium cation with a tetrafluoroborate or bis(trifluoromethanesulfonyl) imide anion;
a 1-hexyl-3-methylimidazolium cation with a tetrafluoroborate, hexafluorophosphate or bis(trifluoromethanesulfonyl) imide anion;
a 1-octyl-3-methylimidazolium cation with a bis(trifluoromethanesulfonyl) imide anion;
a 1-ethanol-3-methylimidazolium cation with a chloride, bromide, tetrafluoroborate, hexafluorophosphate, bis(trifluoromethanesulfonyl) imide or dicyanamide anion.

Mention may also be made, by way of examples, of organic salts based on pyridinium cation, such as: N-butyl-3-methylpyridinium bromide, N-butyl-4-methylpyridinium chloride, N-butyl-4-methylpyridinium tetrafluoroborate, N-butyl-3-methylpyridinium chloride, N-butyl-3-methylpyridinium dicyanamide, N-butyl-3-methylpyridinium methylsulfate, 1-butyl-3-methylpyridinium tetrafluoroborate, N-butylpyridinium chloride, N-butylpyridinium trifluoromethylsulfonate, 1-ethyl-3-tetrafluoroborate, N-butylpyridinium hydroxymethylpyridinium ethyl sulfate, N-hexylpyridinium bis(trifluoromethylsulfonyl) imide, N-hexylpyridinium trifluoromethansulfonate, N-(3-hydroxypropyl)pyridinium bis(trifluoromethylsulfonyl) imide, N-butyl-3-methylpyridinium trifluoromethanesulfonate or N-butyl-3-methylpyridinium hexafluorophosphate.

Mention may also be made, as examples, of organic salts based on a pyrrolidinium cation, such as: 1-butyl-1-methylpyrrolidinium chloride, 1-butyl-1-methylpyrrolidinium dicyanamide, 1-butyl-1-methylpyrrolidinium trifluoromethanesulfonate, 1-butyl-1-methylpyrrolidinium tris(pentafluoroethyl), 1-butyl-1-methylpyrrolidinium bis [oxalato (2-)]borate, 1-butyl-1-methylpyrrolidinium bis(trifluoromethylsulfonyl) imide, 1-butyl-1-methylpyrrolidinium dicyanamide, 1-butyl-1-methylpyrrolidinium trifluoroacetate, 1-butyl-1-methylpyrrolidinium trifluoromethanesulfonate, 1-butyl-1-methylpyrrolidinium tris(pentafluoroethyl) trifluorophosphate, 1,1-dimethylpyrrolidinium iodide, 1-(2-ethoxyethyl)-1-methylpyrrolidinium bis(trifluoromethylsulfonyl) imide, 1-hexyl-1-methylpyrrolidinium bis(trifluoromethylsulfonyl) imide, 1-(2-methoxyethyl)-1-methylpyrrolidinium bis(trifluoromethylsulfonyl) imide, 1-methyl-1-octylpyrrolidinium chloride or 1-butyl-1-methylpyrrolidinium bromide.

Mention may also be made of organic salts combining:
a 1-ethyl-1-methylpyrrolidinium cation with a bromide, tetrafluoroborate, hexafluorophosphate or trifluoromethanesulfonate anion;
a 1-butyl-1-methylpyrrolidinium cation with a chloride, bromide, tetrafluoroborate, hexafluorophosphate, trifluoromethanesulfonate, bis(trifluoromethanesulfonyl) imide, dicyanamide, acetate or hydrogen sulfate anion;
an N-propyl-N-methylpyrrolidinium cation with a bis(trifluoromethanesulfonyl) imide anion;
a 1-methyl-1-propylpiperidinium cation with a bis(trifluoromethanesulfonyl) imide anion.

Mention may also be made, by way of examples, of organic salts based on a guanidine cation, such as: guanidine trifluoromethylsulfonate, guanidine tris(pentafluoroethyl) trifluorophosphate or hexamethylguanidine tris(pentafluoroethyl) trifluorophosphate.

Mention may be made of organic salts based on a phosphonium cation, such as trihexyl(tetradecyl) phosphonium bis [oxalate (2-)] borate, trihexyl(tetradecyl) phosphonium bis(trifluoromethylsulfonyl) imide or trihexyl(tetradecyl) phosphonium tris(pentafluoroethyl) trifluorophosphate.

The list of organic salts and of cations and anions which are mentioned above which can participate in the composition of the organic salts which can be used according to the invention is given solely by way of examples; it is not exhaustive or limiting. Advantageously, the composition according to the invention additionally comprises at least one inorganic salt, that is to say an alkali metal salt or alkaline earth metal salt, among which mention may in particular be made of the salts of alkali metals, such as lithium, sodium, potassium, and the like, and those of alkaline earth metals, such as magnesium, calcium, and the like, with organic acids (mono- or dicarboxylic acids containing from 1 to 12 carbon atoms, for example formic acid, acetic acid, propionic acid, oxalic acid, succinic acid, and the like, sulfonic acids containing from 1 to 20 carbons, for example methanesulfonic acid, p-toluenesulfonic acid, thiocyanic acid, and the like) or mineral acids (halohydric acids, for example hydrochloric acid or hydrobromic acid, perchloric acid, sulfuric acid, phosphoric acid, and the like). Mention may be made of lithium, potassium acetate; lithium chloride, acetate, calcium, magnesium chloride, sodium chloride, bromide, potassium bromide, magnesium, lithium perchlorate, bromide, potassium or sodium perchlorate, potassium sulfate, potassium phosphate, thiocyanate, and the like.

Preference is given, among them, to halides, preferably lithium chloride, sodium chloride or potassium chloride, potassium acetates and potassium perchlorates. The amount of inorganic salt is generally within the range from 0.001% to 3%, preferably 0.01% to 2%, with regard to the weight of the composition.

The composition according to the invention can additionally comprise at least one additive chosen from stabilizers, plasticizers, lubricants, fillers which are natural or organic, dyes, pigments, pearlescent agents, antimicrobial agents, fire retardants, antistatic agents, agents which modify the viscosity of the copolymer, reinforcements, antioxidants, UV stabilizers, flame retardants, mold-release agents, impact modifiers, anti-shrinkage agents, foaming agents, nucleating agents and/or any other additive or adjuvant already mentioned and well known to a person skilled in the art in the field of thermoplastic polymers.

Advantageously, the composition of the invention additionally comprises at least one agent which improves the surface conductivity chosen from: hygroscopic agents; fatty acids; lubricants; metals; metal films; metal powders; metal nanopowders; aluminosilicates; amines, such as quaternary amines; esters; fibers; carbon black; carbon fibers; carbon nanotubes; polyethylene glycol; intrinsically conducting polymers, such as polyaniline, polythiophene or polypyrrole derivatives; masterbatches; and their mixtures.

Another subject matter of the present invention is the use of a composition in accordance with the invention for the manufacture of at least a portion of the following objects: industrial part, automotive part, safety accessory, sign, cornice lighting, information and advertising panel, display case, engraving, furniture, store fitting, decoration, contact ball, dental prosthesis, ophthalmic implant, membrane for hemodialyzer, optical fibers, work of art, decoration, sculpture, lenses, in particular camera lenses, disposable camera lenses, printing medium, in particular a medium for direct printing with UV inks for photographic picture, glazing, sunroof, vehicle headlamps, and the like.

The transparent compositions of the invention have improved antistatic properties due to the decrease in surface resistivity contributed by the PEBA copolymer as described in detail above. The composition according to the invention can be produced by any process well known to a person skilled in the art in the field of polymers, in particular by dry blending, or by kneading at a temperature greater than the glass transition temperature of the various polymers added, or by shearing at a temperature substantially equal to the fluidization temperature of the various polymers added, in particular by calendering, by extrusion, or also by blending in solution.

### EXAMPLES

The following examples illustrate the invention without limiting it.

The copolymers illustrated in the table below are prepared by mixing the monomers in the molten state.

The table shows the content by weight of the blocks present in the copolymer.

TABLE 1

| | | PA | | | | Content of |
|---|---|---|---|---|---|---|
| | PA 11 | MXD10 | PA MXDI | | | aromatic |
| PEBA | (%) | (%) | (%) | PEG (%) | RI | units (%) |
| 1 | 50 | — | 20 | 30 | 1.510 | 20 |
| 2 | 30 | — | 40 | 30 | 1.545 | 40 |
| 3 | — | 70 | — | 30 | 1.533 | 28.2* |
| 4 | — | 55 | 15 | 30 | 1.543 | 37.1 |
| 5 | — | 40 | 30 | 30 | 1.562 | 46.1 |
| 6 | 15 | — | 55 | 30 | 1.600 | 55.0 |
| 7 | — | 60 | 10 | 30 | 1.538 | 34.1 |
| 8 | 35 | — | 35 | 30 | 1.542 | 35.0 |
| 9 | 25 | — | 45 | 30 | 1.556 | 45.0 |

11 = unit resulting from the polycondensation of undecanedioic acid
MXD10 = unit resulting from the polycondensation of m-xylylenediamine and of sebacic acid
MXDI = unit resulting from the polycondensation of m-xylylenediamine and of isophthalic acid
PEG: polyethylene glycol
RI = refractive index measured using the Abbe refractometer according to the standard ISO 489-1999
*the content of aromatic units for copolymer 3 is measured as follows:
$Mm ( MXD ) / Mm ( MXD ) + Mm ( 10 ) \times 70 = 28.2 \%$

1. A block copolymer comprising at least one polyamide block and at least one polyether block, wherein:
the polyamide block comprises at least one unit of formula XDY, in which:
XD denotes a unit resulting from m-xylylenediamine, p-xylylenediamine and their mixtures; and
Y denotes a unit resulting from a linear or branched aliphatic, cycloaliphatic or aromatic dicarboxylic acid comprising from 4 to 36 carbon atoms;
the polyether block comprises ethylene oxide units, in a content of greater than or equal to 20%, with respect to the total weight of the copolymer;
the content of aromatic units is from 20% to 80%, with respect to the total weight of the copolymer.

2. The copolymer as claimed in claim 1, wherein the copolymer exhibits a refractive index of greater than or equal to 1.51.

3. The copolymer as claimed in claim 1, in which the dicarboxylic acid (Y) is chosen from aliphatic diacids having from 6 to 36 carbon atoms, and aromatic dicarboxylic acids having from 6 to 36 carbon atoms.

4. The copolymer as claimed in claim 1, wherein the polyamide block comprises at least one additional unit of formula Z, in which Z denotes a unit obtained by polycondensation of amino acid units, of lactam units or else of units corresponding to the formula (Ca diamine)·(Cb dicarboxylic acid), in which Ca and Cb can each comprise from 4 to 36 carbon atoms.

5. The copolymer as claimed in claim 1, wherein the polyamide block is chosen from: XDI, XDT, XD10/XDI, XD10/XDT, 11/XDI, 11/XDT, XD10/XDI/XDT or 11/XDI/XDT.

6. The copolymer as claimed in claim 1, wherein the ethylene oxide units result from polyethylene glycol or from polyetheramines comprising ethylene oxide units.

7. The copolymer as claimed in claim 1, being chosen from: PA MXD10-PEG, PA MXD11-PEG, PA PXD10-PEG, PA PXD11-PEG, PA MXDT-PEG, PA MXDI-PEG, PA PXDT-PEG, PA PXDI-PEG and/or their mixtures.

8. A transparent antistatic polymer composition comprising:
(a) at least one block copolymer, comprising at least one polyamide block and at least one polyether block, in which the polyamide block comprises at least one unit of formula AY, in which:
A denotes a unit resulting from a linear or branched aliphatic, cycloaliphatic or alkylaromatic diamine, and
Y denotes a unit resulting from a linear or branched aliphatic, cycloaliphatic or aromatic dicarboxylic acid comprising from 4 to 36 carbon atoms;
the content of polyether block of the ethylene oxide units is greater than or equal to 30%, with respect to the total weight of the copolymer;
the content of aromatic units is from 20% to 80%, with respect to the total weight of the copolymer; and
(b) a transparent thermoplastic polymer matrix comprising at least one thermoplastic polymer exhibiting a refractive index of greater than or equal to 1.51.

9. The composition as claimed in claim 8, in which the block copolymer exhibits a refractive index of greater than or equal to 1.51.

10. The composition as claimed in claim 8, in which the diamine A is chosen from butanediamine (denoted 4), pentanediamine (denoted 5), hexanediamine (denoted 6), heptanediamine (denoted 7), octanediamine (denoted 8), nonanediamine (denoted 9), decanediamine (denoted 10), undecanediamine (denoted 11), dodecanediamine (denoted 12), tridecanediamine (denoted 13), tetradecanediamine (denoted 14), hexadecanediamine (denoted 16), octadecanediamine (denoted 18), octadecenediamine (denoted 18), eicosanediamine (denoted 20), docosanediamine (denoted 22) and the diamines obtained from fatty acids, bis(3-methyl-4-aminocyclohexyl) methane (denoted BMACM or MACM), bis(p-aminocyclohexyl) methane (denoted PACM) and isopropylidenedi (cyclohexylamine) (denoted PACP), m-xylylenediamine, p-xylylenediamine and their mixtures.

11. The composition as claimed in claim 8, in which the ethylene oxide units result from polyethylene glycol or from polyetheramines comprising ethylene oxide units.

12. The composition as claimed in claim 8, in which the thermoplastic polymer of the matrix is chosen from polycarbonate (PC), polystyrene, polyethylene terephthalate (PET), polyethylene terephthalate glycol (PETG), polysulfone, acrylonitrile-butadiene-styrene (ABS), styrene-acrylonitrile (SAN), acrylonitrile-styrene-acrylate (ASA), their copolymers and their alloys.

13. The composition as claimed in claim 8, in which the polyamide block additionally comprises at least one unit obtained by polycondensation of amino acid or lactam units.

14. The composition as claimed in claim 8, in which the polyamide block of the copolymer is chosen from 6I/6T, 410/4T, 11/10T, 11T, 5I/5T, XDI, 11/XDI, XDT, XD10/XDI, XD10/XDT, 11/XDT, XD10/XDI/XDT or 11/XDI/XDT, and/or the thermoplastic polymer matrix is chosen from PC, PET or PETG, and/or the content of aromatic units is from 35% to 60%, with respect to the total weight of the copolymer.

15. The composition as claimed in claim 8, comprising an organic salt.

16. A method of using the copolymer as claimed in claim 1 as antistatic additive.
